(19) United States
(12) Patent Application Publication
(10) Pub. No.: US 2002/0074040 A1
(43) Pub. Date: Jun. 20, 2002

(54) Butterfly valve with passive-lubricated liner/seat

(76) Inventor: Philip R. Schwarz, Clovis, CA (US)

Correspondence Address: SHERIDAN ROSS PC, 1560 BROADWAY, SUITE 1200, DENVER, CO, 80202

(21) Appl. No.: 09/982,593

(22) Filed: Oct. 17, 2001

Related U.S. Application Data
(60) Provisional application No. 60/241,288, filed on Oct. 17, 2000.

(51) Int. Cl. F16K 1/22

(52) U.S. Cl. 137/375; 251/305; 251/366

(57) ABSTRACT

A butterfly valve is provided with a seat/liner which is injection-molded directly against the valve body. The seat/liner includes a passive lubricant which is preferably silicone. The seat/liner preferably covers substantially all of the valve body conduit surface, preventing any contact of fluid flow with the valve body. Preferably the seat/lining bonds directly to the valve body without the need for an adhesive material or layer. In one aspect, the seat/liner includes a lip portion extending radially outward, e.g., at the attachment faces of the valve body.

### CROSS REFERENCE TO RELATED APPLICATION

Priority is claimed from U.S. Provisional Application Serial No. 60/241,288 filed Oct. 17, 2000 entitled “Butterfly Valve With Passive-Lubricated Liner/Seat,” which is incorporated by reference herein in its entirety.

### FIELD OF THE INVENTION

The present invention relates to a butterfly valve such as used for moderate-pressure, 3-inch to 24-inch water or other flow lines, and in particular to a butterfly valve with a valve seat having passive lubrication.

### BACKGROUND INFORMATION

Butterfly valves, having a disk, rotatable about an axis passing through the disk diameter, are used in a wide variety of applications including, e.g., municipal water, power and other industrial applications. Although some or all features of the present invention can be used in a variety of different butterfly valve devices, the present invention is especially useful in the context of so-called low performance valves such as those having a three inch to 24 inch (7 cm to 60 cm) diameter, typically operating at pressures less than about 300 psi (2000 KPa), temperatures below about 180° F. (80°C.) and typically used for fluids which are not normally considered highly corrosive. Nevertheless, even when used in connection with water or generally non-corrosive fluids, there can be a potential for mineral deposition, oxidation, or other chemical interaction which can provide an undesired amount of corrosion. Corrosion can have a number of undesirable consequences, including impeding flow and/or increasing head loss, interfering with the movement or seal achievable by the disk and/or impairment of water (or other fluid) quality. Accordingly, it would be useful to provide a butterfly valve with a relatively low susceptibility to corrosion and similar effects. Preferably, the butterfly valve promotes smooth fluid flow with relatively low head loss, maintains ease of disk movement and sealing, and avoids fluid quality degradation.

In some approaches, a butterfly valve was provided with a valve seat which was formed and then separately attached to the valve body, such as using a plurality of bolts or similar connectors. Typically, in such designs, the edge or interface between the valve seat and a seat-holder (or the valve body) was exposed to the fluid flow and there was a potential for full or partial separation of the seat, particularly when the interface was exposed, over a long period of time to flow with potentially large variations in pressure, flow rate and/or fluid temperature, thus creating a potential failure mode.

Accordingly, it would be useful to provide a butterfly valve which can reduce or eliminate the potential for certain failure modes, reduce the potential for valve seat separation, and in general provide a valve with high longevity and low maintenance requirements throughout its service life (which is preferably many years), even when exposed to substantial changes in pressure, flow rates, temperatures and the like.

In some previous approaches, a glue, cement, adhesive or the like was used for securing a valve seat in a desired position. This approach, however, can present a potential for contaminating the fluid with the glue or adhesive which can be highly undesirable when the fluid is, e.g., potable water or other fluid where fluid quality is of concern. Accordingly, it would be useful to provide a butterfly valve which can reduce or eliminate the potential for contamination by a valve seat glue, cement, adhesive or the like.

In order for the butterfly valve to achieve compliance with standards such as American Water Works Association (AWWA) C504 or other standards or testing requirements, and for butterfly valves to maintain compliance with such standards over a long service life, it is important, among other requirements, for the butterfly disk and the disk seat to properly seal with respect to one another over repeated openings and closings, and under a variety of temperature, pressure and flow conditions. Accordingly, it would be useful to provide a butterfly valve with improved disk/disk seat (sustained) sealing properties.

### SUMMARY OF THE INVENTION

The present invention includes a recognition of certain problems in previous approaches, including as described herein. According to one aspect, a resilient valve seat for a butterfly valve, rather than being a separate piece which is coupled by bolts or other connectors, is instead injection-formed or injection-molded directly into or onto the valve body itself. Preferably, the valve seat covers substantially the entire surface of the valve body which would be in contact with the flow and preferably defines a lip extending radially outwardly somewhat beyond the flow diameter. In at least some configurations, there is substantially no seat-body interface exposed to the flow (except, in some embodiments, at the shaft-openings). In at least one embodiment, the seat material includes a passive lubricant (i.e., a material which enhances the lubricity or decreases sliding friction, and does not need to be externally or separately applied). In one embodiment, passive lubrication is provided by adding an amount preferably between about 0.01% and about 10%, more preferably close to 2%, of silicone to a valve seat material such as neoprene, buna-N, and the like.

In one aspect, a butterfly valve is provided with a seat/liner which is injection-molded directly against the valve body. The seat/liner includes a passive lubricant which is preferably silicone. The seat/liner preferably covers substantially all of the valve body conduit surface, preventing any contact of fluid flow with the valve body. Preferably the seat/lining bonds directly to the valve body without the need for an adhesive material or layer. In one aspect, the seat/liner includes a lip portion extending radially outward, e.g., at the attachment faces of the valve body.

### BRIEF DESCRIPTION OF THE DRAWINGS

FIG. 1 is a perspective view of a valve body with installed seat according to an embodiment of the present invention;

FIG. 2 is a front elevational view of the body and seat of FIG. 1;

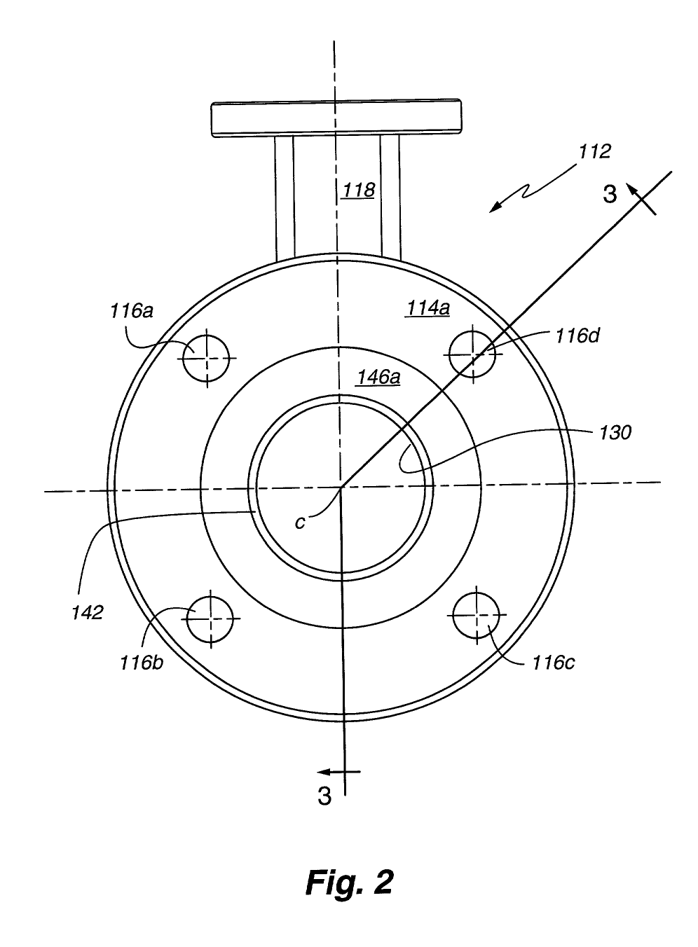

FIG. 3 is a cross-sectional view taken along line 3-C-3 of FIG. 2;

FIG. 4 is a perspective, partially cutaway view of a butterfly valve according to an embodiment of the present invention; and

FIG. 5 is a cross-sectional view of a valve body and injection mold parts, according to an embodiment of the present invention.

### DETAILED DESCRIPTION OF THE PREFERRED EMBODIMENTS

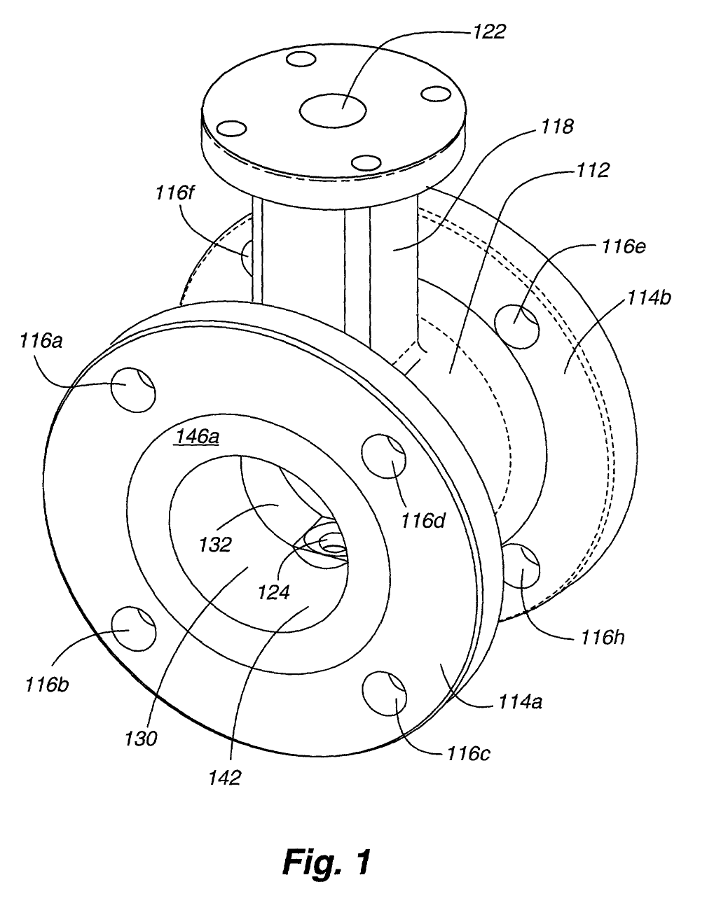

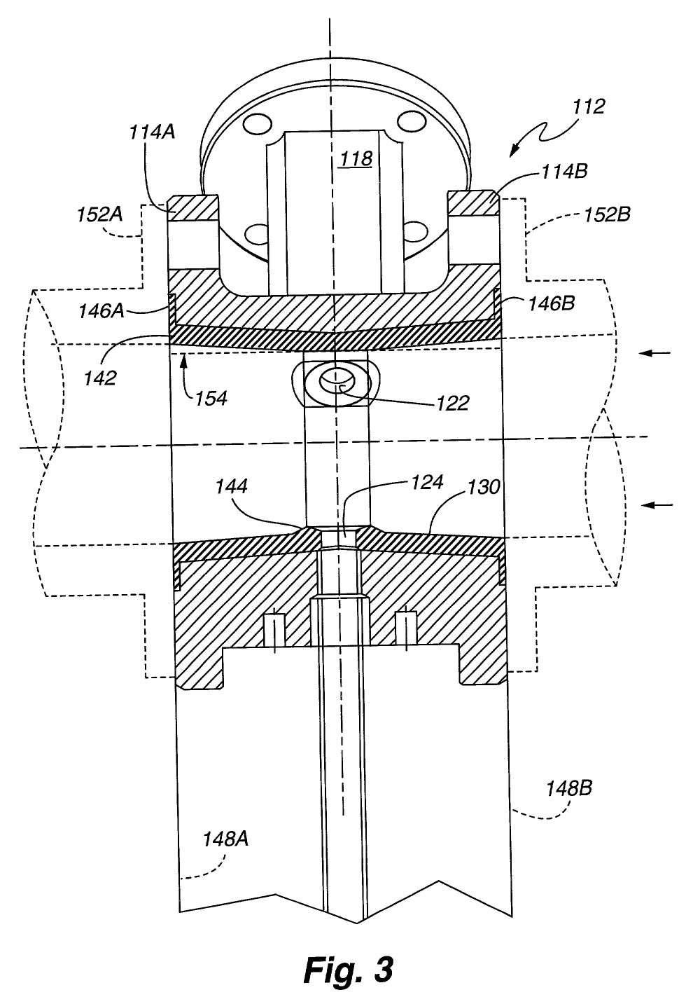

As shown in FIG. 1, a valve body 112, according to an embodiment of the present invention, includes first and second parallel flanges 114a,b each having bolt holes 116a,b,c,d,e,f,g,h, e.g., for coupling the valve body 112 to pipes or other conduits 152a,b (see FIG. 3). The body 112 can be formed of a number of materials including, e.g., cast iron and/or ductile iron. A shaft body 118 defines a shaft opening 122 for receiving the valve disk shaft, as described below. A second, opposed opening 124 receives the opposite end region of the shaft.

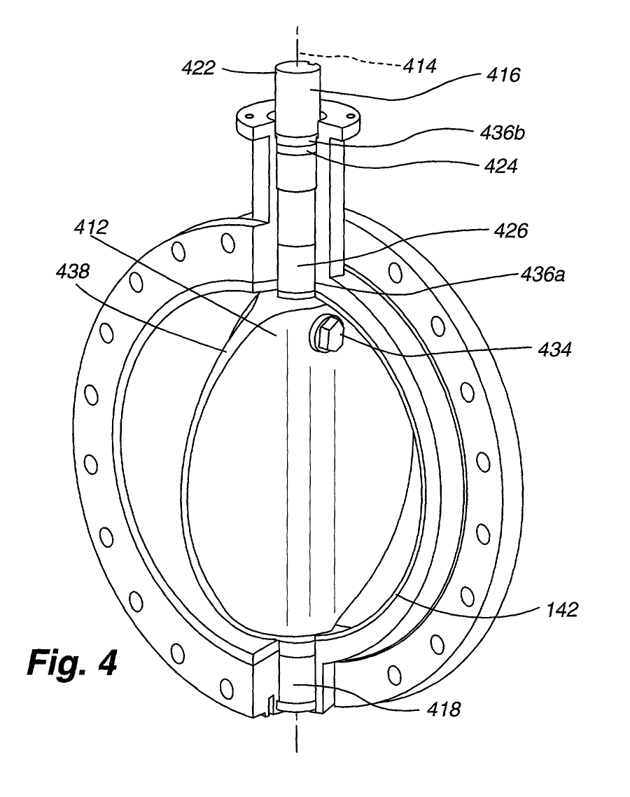

A generally cylindrical opening 130 defines the region through which fluid will flow when the valve is at least partially opened. As described below, a valve disk 412 (FIG. 4) is mounted so as to be rotatable about an axis 414 to prevent, permit and/or control the flow through the valve. The disk 412 can be formed of a number of materials including metals, ceramics and the like. In one embodiment, the main portion of the disk 412 is cast iron with the (preferably highly polished) disk edge 438 being stainless steel. Preferably, the faces of the disk are coated with a durable, substantially inert material, such as by using fusion coated epoxy. In the embodiment illustrated in FIG. 4, the shaft 416 has a distal end 418 received in the valve body opening 124 and a proximal end 422 extending through the shaft body 118. The shaft 416, in the illustrated embodiment, is mounted so as to permit rotation about the axis 414, e.g., using preferably corrosion resistant bushings 418, (preferably permanently lubricated) bearings 426 and the like. The bushings can be formed of a number of materials including polyester or other plastic or thermal-formable materials. A number of types of bearings can be used including fabric lined stainless steel bearings. The shaft 416 is coupled to the disk 412 so as to rotate therewith about axis 414, e.g., by a threaded bolt or plug 434. Preferably, seals 436a, 436b avoid loss of fluid through the shaft body 118 and/or potential entry of contaminants or other undesired material into the flow through the shaft body 118. The shaft 416 can be formed of a number of materials and is preferably made of stainless steel.

Preferably, prior to assembly of the butterfly valve (e.g., by assembling the shaft 416 and disk 412 into the valve body 112), the body 112 is provided with a structure which forms the valve seat and which preferably also substantially or totally lines the flow-exposed surfaces of the valve body.

Preferably, the seat/liner 142 is formed of a material which is substantially chemically inert with respect to the water or other fluid which will pass through the valve, at least somewhat resiliently compressible and/or elastic, to form a sufficiently tight seal with respect to the disk (when in the closed position) and preferably maintains the desired qualities throughout a range of temperature, flow velocity or pressure conditions over a substantial lifetime. In one embodiment, the seat/liner is largely formed of a synthetic rubber and/or vulcanized rubber and/or buna-N and/or nitrile and/or neoprene and/or ethylene propylene diene monomer (EPDM) or the like. In some applications, it may be useful to select the seat/liner material on the basis of the materials or fluid to be handled and/or operating conditions expected. For example, conditions where the fluid may have a high chlorine content, EPDM or silicone may be selected. Those of skill in the art will understand how to select operable materials for various fluids and conditions after understanding the present disclosure.

The shape, thickness or other dimensions and the like of the seal/liner 142 will depend on factors such as the shape and size of the valve body 112, the disk 412 and the like. In the embodiment depicted in FIG. 3, the seat/liner exterior surface tapers or flares outward towards the front and rear surfaces 148a, 148b at an angle 154. Preferably, the seat/liner 142 substantially covers the entire cylindrical flow region 130, except for the shaft openings 122, 124, e.g., so that the fluid never contacts any portion of the valve body directly. Preferably, the seat/liner 142 in the region of the shaft openings 122, 124 is configured to provide a tight and/or close-fitting seal with respect to the shaft 416 and/or disk 412. For example, as depicted in FIG. 3, the seat/liner 142, in the region near the lower shaft opening 124 may be configured with a substantially annularly peaked shape 144, e.g., substantially mating with a corresponding portion of the shaft and/or disk 412.

Preferably, the fluid flowing through the valve never contacts a seat/body interface. Avoiding such interface can assist in avoiding disattachment of a portion of the seat/lining (e.g., as might occur if high pressure fluid impacts an interface edge or the like) and avoids any potential for dissolving or entraining chemicals, particles and the like which my reside in the body/liner interface. In the depicted embodiment, partially to assist in avoiding exposure of the flow to an interface, the seat/liner 142 is formed with lips 146a,b extending radially outward substantially along the face planes 148a,b. In general, at least portions of the lips 146a,b will seal or mate with respect to pipes, conduits or other similar items 152a,b coupled to the faces of the butterfly valve.

It has been found that, in at least one embodiment, it can be useful or important to provide an amount of lubricity, preferably by using a passive lubricant, in the seat/liner. The provision of a passive lubricant can assist in avoiding wear, deformation, tearing and the like of the seat/liner during operation of the valve and can assist in smoothly moving the disk between the opened and closed positions and reducing the force required for such movement.

In one embodiment, an amount of silicone (inorganic siloxane polymer) is included in the formulation of the material used for the seat/liner. In one embodiment, the material used for the seat/liner includes at least about 0.5%, preferably about 1% and more preferably at least about 2% silicone.

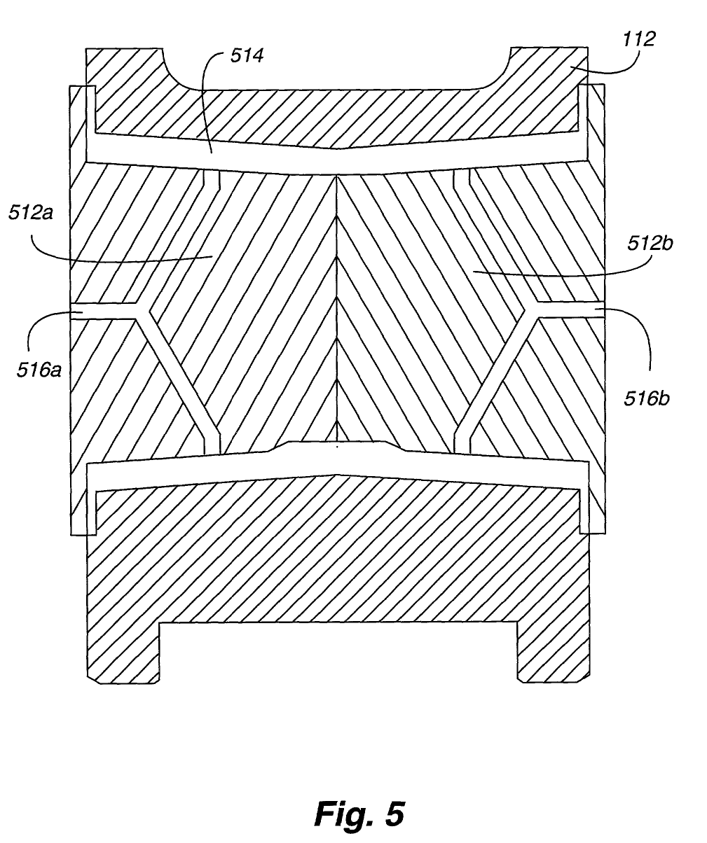

According to one embodiment of the invention, the seat/liner material is injection molded directly onto surfaces of the valve body 112. In the embodiment depicted in FIG. 5, the substantially-formed valve body 112 forms one portion of an injection mold. First and second mold parts 512a,b are inserted generally along the fluid flow axis, mating with one another and with the valve body 112 to define a substantially cylindrical cavity 514 in the shape of the desired seat/liner. The mold portions 512a are configured to produce the desired shape, thickness and form of the seat/liner, including features as described and depicted above including openings, lips, ridges and the like. The injection mold portions 512a are provided with injection ports 516a,b communicating with the cavity 514 and the injection material is injected through the ports to substantially fill the cavity 514 forming the seat/liner in the desired shape, preferably bonding or adhering substantially directly to the surfaces of the valve body 112. In one embodiment, the seat/liner material achieves a bond, with respect to the valve body, which complies with various testing results or standards including, e.g., ASTM D 429 (Method B). In the depicted embodiment the seat/liner exterior surface tapers or flares outward towards the front and rear surfaces 148a, 148b at an angle 154.

In light of the above-description, a number of advantages of the present invention can be seen. The present invention provides a practical and feasible system and device for a butterfly valve which can substantially reduce or eliminate the potential for chemical interactions which can degrade the quality of the water or other fluid which flows through the valve and/or which can corrode or otherwise damage the valve. The present invention can substantially avoid contact of the fluid with any portion of the valve body directly and/or with a valve body/liner interface. The present invention makes it possible to substantially eliminate the potential for leaching of an adhesive (such as previously used for attaching a seat or a liner to a valve body) into the fluid. The present invention can substantially reduce friction of moving parts such as the disk or shaft with respect to the seat/liner to provide ease of operation and avoid the potential for deformation or damage to the seat/liner.

A number of variations and modifications of the invention can be used. It is possible to use some aspects of the invention without using others. For example, it is possible (but not necessarily advisable) to provide for injection/molding of a seat/liner without providing for a passive lubricant. It is possible to provide embodiments of the present invention which do not include certain of the described features such as the lip, the peaked annular seal, and/or substantial covering of all flow-exposed areas. Although the present invention was described in the context of a butterfly valve, some or all features of the present invention may be used in connection with other types of valves including globe valves, ball valves, flapper valves, poppet valves and the like. Although embodiments of the present invention are believed to be particularly useful in connection with low performance valves, it is also possible to use some or all features of the present invention in connection with high performance valves. Although embodiments having flanges and bolt holes for coupling to conduits have been illustrated, other connecting devices and approaches can be used including groove and lip (socket) connections and the like. In some embodiments, the valve seat lip or other portions of the valve seat can be used for forming at least a portion of a seal between the valve and attached conduits. Although the Seal and liners are preferably formed in a single piece, it would also be possible to provide the seat and liner as separate pieces.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g. for improving performance, achieving ease and or reducing cost of implementation. The present invention includes items which are novel, and terminology adapted from previous and/or analogous technologies, for convenience in describing novel items or processes, do not necessarily retain all aspects of conventional usage of such terminology.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A butterfly valve apparatus, comprising:
a valve body having at least a first conduit having a conduit wall surface defining a first flow axis;
a seat/lining directly injection-molded adjacent at least a portion of said conduit surface, said seat/lining including a passive lubricant; and
a disk mounted with respect to said valve body so as to move between an open position substantially permitting flow through said conduit and a closed position contacting at least a portion of said seat/liner forming a seal therewith to substantially prevent flow through said conduit.

2. An apparatus, as claimed in claim 1, wherein said passive lubricant comprises silicone.

3. An apparatus, as claimed in claim 1, wherein said passive lubricant comprises at least about 0.5% silicone.

4. An apparatus, as claimed in claim 2, wherein said passive lubricant comprises at least about 1% silicone.

5. An apparatus, as claimed in claim 2, wherein said passive lubricant comprises at least about 2% silicone.

6. An apparatus, as claimed in claim 1, wherein said seat/lining substantially covers all portions of said conduit wall surface such that no portion of said surface is exposed directly to fluid flow.

7. An apparatus, as claimed in claim 1, wherein said valve body includes at least a first opening for accommodating a disk shaft and wherein said seat/lining is configured, in a region adjacent said opening, to substantially seal with a portion of at least one of said disk and said disk shaft.

8. An apparatus, as claimed in claim 1, wherein at least a first surface of said seat/lining flares radially outwardly along said flow axis.

9. An apparatus, as claimed in claim 1, wherein at least a portion of said seat/lining is substantially bonded to said valve body in the absence of the need for a separate adhesive material.

10. A method useable in connection with forming a butterfly valve comprising:
providing a valve body having a first conduit defined by a conduit surface said body including at least a first opening for accommodating a disk for operable engagement within said conduit;
positioning a injection mold body, having at least a first injection port, spaced from at least a portion of said conduit surface to define a cavity with respect to said conduit surface; and
injecting a molding material into said cavity to directly contact said portion of said conduit surface wherein said molding material includes a passive lubricant.

11. A method, as claimed in claim 10, wherein said passive lubricant comprises silicone.

12. A method, as claimed in claim 11, wherein said passive lubricant comprises at least about 0.5% silicone.

13. A method, as claimed in claim 11, wherein said passive lubricant comprises at least about 1% silicone.

14. A method, as claimed in claim 11, wherein said passive lubricant comprises at least about 2% silicone.

15. A method, as claimed in claim 10, wherein said seat/liner substantially covers all portions of said surface such that no portion of said surface is exposed directly to fluid flow.

16. A method, as claimed in claim 1, wherein said valve body includes at least a first opening for accommodating a disk shaft coupleable to a disk and further comprising:
mounting said disk shaft and disk in said conduit after said step of injection molding, wherein said seat/liner is configured, in a region adjacent said opening, to substantially seal with a portion of at least one of said disk and said disk shaft.

17. A method, as claimed in claim 1, wherein during said step of injection molding, at least a portion of said seat/liner is substantially bonded to said valve body in the absence of the need for a separate adhesive material.

18. A butterfly valve apparatus, comprising:
a valve body having at least a first conduit means defining a first flow axis, said conduit means having a conduit wall surface in said valve body;
valve seat means directly injection-molded adjacent at least a portion of said conduit surface, said valve seat means including a passive lubricant; and
disk means for opening and closing said valve apparatus, mounted with respect to said valve body so as to move between an open position substantially permitting flow through said conduit and a closed position contacting at least a portion of said seat/liner forming a seal therewith to substantially prevent flow through said conduit.

19. An apparatus, as claimed in claim 18, wherein said passive lubricant comprises silicone.

20. An apparatus, as claimed in claim 19, wherein said passive lubricant comprises at least about 0.5% silicone.

21. An apparatus, as claimed in claim 19, wherein said passive lubricant comprises at least about 1% silicone.

22. An apparatus, as claimed in claim 19, wherein said passive lubricant comprises at least about 2% silicone.

23. An apparatus, as claimed in claim 18, wherein said valve seat means is a means for substantially preventing direct exposure of said wall surface to fluid flow.

24. An apparatus, as claimed in claim 18, wherein said valve body means includes at least a first means for accommodating a disk shaft and wherein said valve seat means is a means for substantially sealing, in a region adjacent said first means, with a portion of at least one of said disk and said disk shaft.
